(19) United States
(12) Patent Application Publication
(10) Pub. No.: US 2024/0054193 A1
(43) Pub. Date: Feb. 15, 2024

(54) AUTHENTICATING A USER BASED ON EXPECTED BEHAVIOUR

(71) Applicant: Telefonaktiebolaget LM Ericsson (publ), Stockholm (SE)

(72) Inventors: Tommy ARNGREN, Södra Sunderbyn (SE); Bernard SMEETS, Dalby (SE); Peter ÖKVIST, Luleå (SE)

(73) Assignee: Telefonaktiebolaget LM Ericsson (publ), Stockholm (SE)

(21) Appl. No.: 18/267,923

(22) PCT Filed: Dec. 18, 2020
(86) PCT No.: PCT/SE2020/051241

§ 371 Date: Jun. 16, 2023

(51) Int. Cl. G06F 21/31

(52) U.S. Cl. CPC G06F 21/316

(57) ABSTRACT

It is provided a method for authenticating a user (5). The method is performed in an authenticator (1) and comprises the steps of: obtaining (40) context data reflecting a current context of the user (5); determining (42) a user challenge set for the user (5) to perform based on the context data, the user challenge set comprising at least one user challenge, wherein each user challenge indicates an action for the user(5) to perform in relation to at least one object (10a-I); transmitting (44) the user challenge set to a user device (2), for presenting the user challenge set to the user (5); obtaining (46) media data; determining (47) a behaviour of the user (5) captured in the media data; and authenticating (48) the user (5), when the media data indicates an expected behaviour of the user (5) in response to the user challenge set.

### TECHNICAL FIELD

The present disclosure relates to the field of authentication and in particular to authenticating a user based on observing whether an expected behaviour of the user occurs when the user is presented with a user challenge set of at least one user challenge.

### BACKGROUND

A fundamental problem in many types of electronic devices, such as mobile phones, computers, etc. is the question how to authenticate the user and become confident that it is a human user.

For authentication, various technologies exist today, including passwords, personal identification numbers (PINs) and digital certificates. More and more, biometrics, such as face recognition, fingerprint recognition, iris recognition, etc. are also used for authentication.

For the human user determination, there are also known solutions, such as Captcha, where the user is provided an image with semi-obfuscated text that is to be entered e.g. using a keyboard. Another example is multi-factor authentication where the user is requested to input an additional code sent to a mobile phone or e-mail, or that is generated in a separate application of the user device.

For many users, it has become cumbersome to remember the different passwords/PINs. The use of biometrics does address some of the issues of passwords/PINs, but the handling and storage of sensitive biometric data is an issue. The biometric data of the user may not be fully controllable by the user, nor fully contained in the devices, e.g. giving fingerprint data away at readers at national boarder entry points. This causes a security issue as, e.g. fingerprint, face recognition metric, and so forth, may be intercepted or stored by authorities, third party, cloud services, various apps, etc.

### SUMMARY

One object is to provide an authentication which is simple for the user, yet does not store privacy-sensitive data for verification.

According to a first aspect, it is provided a method for authenticating a user. The method is performed in an authenticator and comprises the steps of: obtaining context data reflecting a current context of the user; determining a user challenge set for the user to perform based on the context data, the user challenge set comprising at least one user challenge, wherein each user challenge indicates an action for the user to perform in relation to at least one object; transmitting the user challenge set to a user device, for presenting the user challenge set to the user; obtaining media data; determining a behaviour of the user captured in the media data; and authenticating the user, when the media data indicates an expected behaviour of the user in response to the user challenge set.

The step of determining a user challenge set may be based on a first machine learning, ML, model.

The method may further comprise the step of: training the first ML model based on the media data and the context data.

The training may also be based on a result of the authenticating.

The step of authenticating may comprise identifying one or more objects in the media data based on a second ML model.

The step of authenticating may comprise determining when the behaviour comprises movement characteristics that are associated with the user.

On the step of authenticating, the expected behaviour may be determined based on a match threshold.

The match threshold may depend on security requirements.

The match threshold may depend on the context data.

The steps of determining a user challenge set, transmitting the user challenge set, obtaining media data, and authenticating may be repeated when the authentication fails.

In the step of determining a user challenge set, at least one user challenge may omit a detail of the user challenge which is expected to be known by the user, in which case the step of authenticating comprises verifying presence of the expected detail.

The context data may comprise location data and/or a timestamp.

At least one object may be a physical object.

At least one object may be a virtual object in an extended reality, XR, environment.

According to a second aspect, it is provided an authenticator for authenticating a user. The authenticator comprises: a processor; and a memory storing instructions that, when executed by the processor, cause the authenticator to: obtain context data reflecting a current context of the user; determine a user challenge set for the user to perform based on the context data, the user challenge set comprising at least one user challenge, wherein each user challenge indicates an action for the user to perform in relation to at least one object; transmit the user challenge set to a user device, for presenting the user challenge set to the user; obtain media data; determine a behaviour of the user captured in the media data; and authenticating the user, when the media data indicates an expected behaviour of the user in response to the user challenge set.

The instructions to determine a user challenge set may comprise instructions that, when executed by the processor, cause the authenticator to determine the user challenge set is based on a first machine learning, ML, model.

The authenticator may further comprise instructions that, when executed by the processor, cause the authenticator to: train the first ML model based on the media data and the context data.

The instructions to train may comprise instructions that, when executed by the processor, cause the authenticator to train the first ML model also based on a result of the authenticating.

The instructions to authenticate may comprise instructions that, when executed by the processor, cause the authenticator to identify one or more objects in the media data based on a second ML model.

The instructions to authenticate may comprise instructions that, when executed by the processor, cause the authenticator to determine when the behaviour comprises movement characteristics that are associated with the user.

The instructions to authenticate may comprise instructions that, when executed by the processor, cause the authenticator to, determine the expected behaviour based on a match threshold.

The match threshold may depend on security requirements.

The match threshold may depend on the context data.

The authenticator may further comprise instructions that, when executed by the processor, cause the authenticator to repeat the instructions to determine a user challenge set, transmit the user challenge set, obtain media data, and authenticate when the authentication fails.

The at least one user challenge may omit a detail of the user challenge which is expected to be known by the user, in which case the instructions to authenticate comprise instructions that, when executed by the processor, cause the authenticator to verify presence of the expected detail.

The context data may comprise location data and/or a timestamp.

At least one object may be a physical object.

At least one object may be a virtual object in an extended reality, XR, environment.

According to a third aspect, it is provided an authentication system comprising the authenticator according to the second aspect and a user device to which the authenticator is configured to transmit the user challenge set.

According to a fourth aspect, it is provided a computer program for authentication a user. The computer program comprising computer program code which, when executed on an authenticator causes the authenticator to: obtain context data reflecting a current context of the user; determine a user challenge set for the user to perform based on the context data, the user challenge set comprising at least one user challenge, wherein each user challenge indicates an action for the user to perform in relation to at least one object; transmit the user challenge set to a user device, for presenting the user challenge set to the user; obtain media data; determine a behaviour of the user captured in the media data; and authenticating the user, when the media data indicates an expected behaviour of the user in response to the user challenge set.

According to a fifth aspect, it is provided a computer program product comprising a computer program according to the fourth aspect and a computer readable means on which the computer program is stored.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated.

### BRIEF DESCRIPTION OF THE DRAWINGS

Aspects and embodiments are now described, by way of example, with reference to the accompanying drawings, in which:

FIGS. 1A-B are schematic diagrams illustrating environments in which embodiments presented herein can be applied;

FIG. 2 is a sequence diagram illustrating communication between the user device and an authenticator, which can be applied in the environment of FIGS. 1A-B;

FIGS. 3A-B are flow charts illustrating embodiments of methods for authenticating a user;

FIGS. 4A-D are schematic diagrams illustrating embodiments of where the authenticator of FIG. 2 can be implemented.

FIG. 5 is a schematic diagram illustrating components of the authenticator of FIGS. 4A-D according to one embodiment;

FIG. 6 is a schematic diagram showing functional modules of the authenticator of FIG. 5 according to one embodiment; and

FIG. 7 shows one example of a computer program product comprising computer readable means.

### DETAILED DESCRIPTION

The aspects of the present disclosure will now be described more fully hereinafter with reference to the accompanying drawings, in which certain embodiments of the invention are shown. These aspects may, however, be embodied in many different forms and should not be construed as limiting; rather, these embodiments are provided by way of example so that this disclosure will be thorough and complete, and to fully convey the scope of all aspects of invention to those skilled in the art. Like numbers refer to like elements throughout the description.

In embodiments presented herein a user is authenticated for a user device by an authenticator. The authenticator determines one or more user challenges that are presented to the user. The behaviour of the user is captured, e.g. using a video camera, and evaluated to see if the behaviour sufficiently matches expected behaviour based on the one or more challenges. This solution thus authenticates the user without needing password, nor privacy-sensitive biometric data.

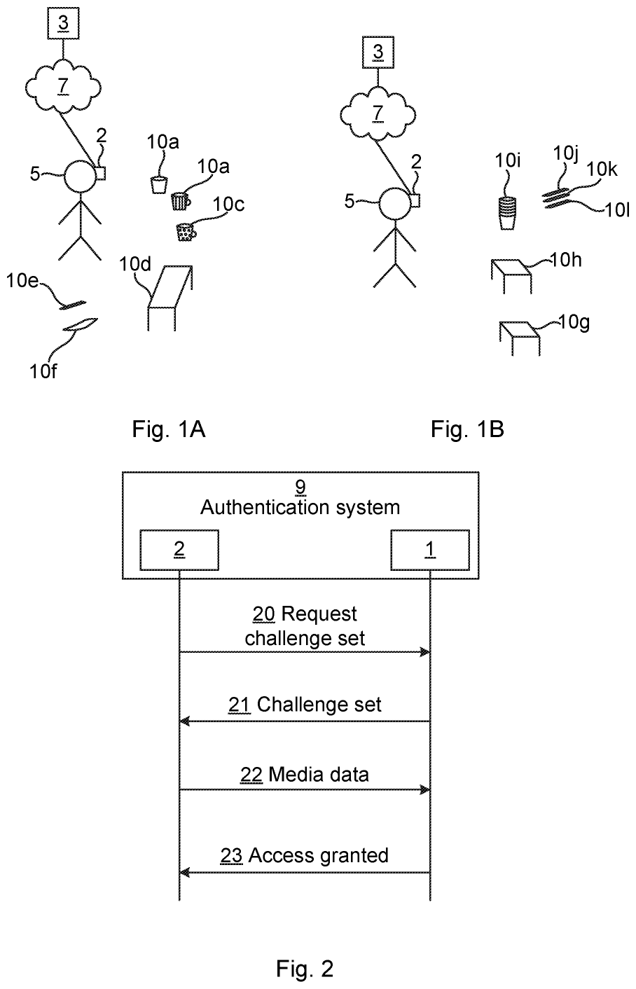

FIGS. 1A-B are schematic diagrams illustrating environments in which embodiments presented herein can be applied. A user 5 wears or carries a user device 2 comprising an image capturing device, such a camera (3D or 2D), lidar, radar, etc. or any combination of these. The user device 2 can e.g. be a head mounted display (HMD) or a mobile phone. The user device 2 can be configured to support extended reality (XR), such as augmented reality (AR) or virtual reality (VR). In AR, the user 5 can see both real-world objects and overlaid virtual objects. Virtual objects are rendered by the user device 2 and do not exist as physical objects. In VR, the user 5 can mainly or only see virtual objects. Hereinafter, unless explicitly indicated otherwise, whenever the term object is used, it can refer to a real-world object or a virtual object.

The user device 2 is connected to a network 7. The network 7 can be based in Internet protocol (IP) communication over any one or more of a local wireless network (e.g. any of the IEEE 802.11x standards), a short-range wireless link (e.g. Bluetooth), a local area network (LAN), a wide area network (WAN) such as the Internet and a cellular network. A server 3 is also connected to the network 7. The server 3 can be what is called ‘in the cloud’, either at a central location or at a so-called edge-cloud location, topologically closer to the user device 2.

Looking now to the scenario depicted in FIG. 1A, the user 5 is in a first location, e.g. in her home. Around the user 5, there are here six objects shown: a first cup 10a, a second cup 10b, a third cup 10c, a table 10d, a first pen 10e, and a second pen 10f.

The function of these objects will be described with reference to FIG. 2 below.

Looking now to the scenario depicted in FIG. 1B, the user 5 is in a second location, e.g. in her office. Around the user 5, there are here six objects shown: a stack of paper cups 10i, a third pen 10j, a fourth pen 10k, a fifth pen 10l, a first desk 10h and a second desk 10g.

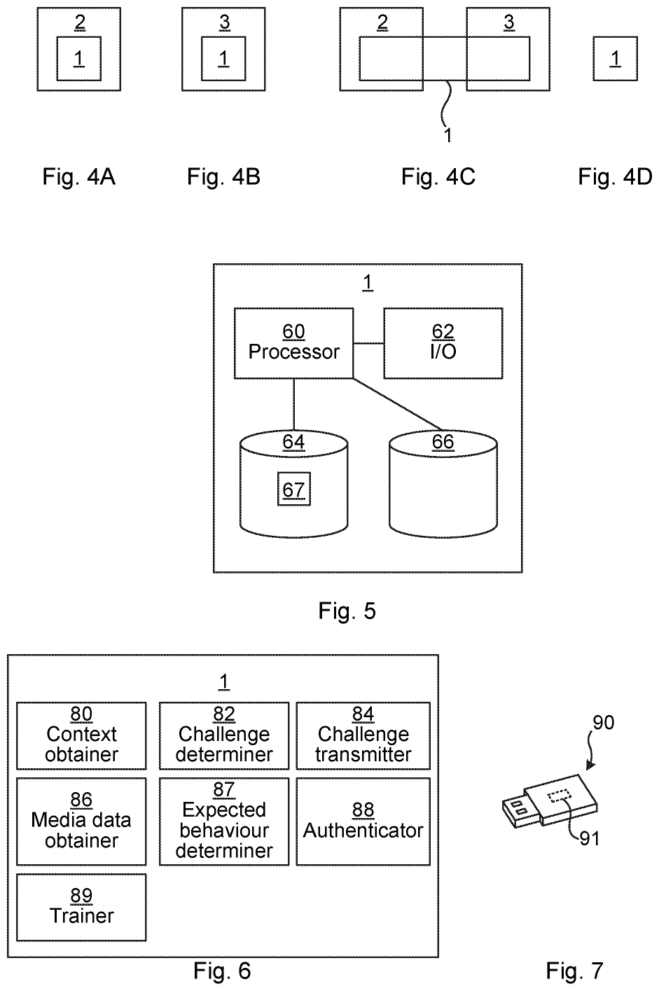

FIG. 2 is a sequence diagram illustrating communication between the user device 2 and an authenticator 1, which can be applied in the environment of FIGS. 1A-B. Collectively, the user device 2 and the authenticator 1 can make up an authentication system 9. The communication illustrated in FIG. 2 will now be described with reference also to FIGS. 1A-B, where the user 5 is authenticated. The communication occurs between the user device 2 and an authenticator 1. As shown in FIGS. 4A-D, the authenticator 1 can be a standalone device or be implemented in a server 3. The authenticator 1 can also be implemented internally in the user device 2 or partly in the user device 2 and partly in the server 3, in which case the communication of FIG. 2 is at least partly based on internal communication.

The sequence starts when the user device 2 needs to authenticate a user 5, which can e.g. occur when the user 5 desires access to the user device 2, or for a particular action, such as purchasing software or for applying a cryptographic signature.

Initially, the user device 2 requests 20 a user challenge set from the authenticator to start the authentication process. The request can contain an identifier of the user to authenticate, i.e. is the person at the user device the user identified by the user identifier?

The authenticator also obtains context data relating to the user device 2. This can be included in the request from the user device 2 and/or obtained separately by the authenticator obtaining context data by requesting this, from the user device 2, from other entities and/or internally within the authenticator. The context data can contain e.g. data indicating the location of the user device and/or the current time and date. Based on the request 20 and the context data, the authenticator 1 generates one or more user challenges. Each user challenge will be presented to the user, affecting the user behaviour in some way. Referring to FIGS. 1A-B, the context data can thereby define when the user 5 is at home (FIG. 1A) or at the office (FIG. 1B).

In a first example, when the context data indicates that the user is at home (FIG. 1A), a user challenge can be “put your favourite cup on the table and balance your favourite pen on the cup”.

In a second example, when the user is at the office (FIG. 1B), a user challenge can be “take a cup and put it in your usual spot at your desk”. Several user challenges can be determined for a sequence of user challenges in the user challenge set. In any case, the one or more user challenges form a user challenge set. Once determined, the authenticator 1 transmits the user challenge set 21 to the user device.

The user device 2 presents the user challenge set to the user 5, e.g. using text, voice synthesis, etc. and the user 5 performs the user challenge with a certain behaviour, using body movement.

In the first example, if the person is the correct user, she will know that her favourite cup is the second cup 10b, which is the striped cup. Furthermore, the user 5 will know that her favourite pen is the fountain pen, the second pen 10f. So, when given the instruction “put your favourite cup on the table and balance your favourite pen on the cup”, the user 5 will put the second cup 10b on the table 10d and balance the second pen 10f on top.

In the second example, if the person is the correct user, she will know that her desk is the second desk 10g and, since she is left-handed, she likes to put her cup on the left, usually about 200 mm from the left edge. So, when given the instruction “take a cup and put it in your usual spot at your desk”, the user 5 will take a paper cup 10i and place it on the left hand side, about 200 mm from the left edge on the second desk 10g. Alternatively, in an XR environment, the user's favourite cup is rendered as a virtual object in the office environment, in which case the user can be asked to fetch her favourite cup even if this is only rendered as a virtual object and is not located in the vicinity of the user as a real-life object.

The behaviour of the user is captured by the user device 2 and transmitted as media data 22 to the authenticator.

At this stage, the actual authentication occurs by the authenticator 1. The authenticator checks whether the behaviour of the user is captured in the media data 22. This can comprise checking that the correct object is manipulated and that the expected action has been performed, in accordance with what is described above.

When access is granted, this is communicated 23 to the user device 2. The person by the device is now authenticated to be the user 5 for the user device 2.

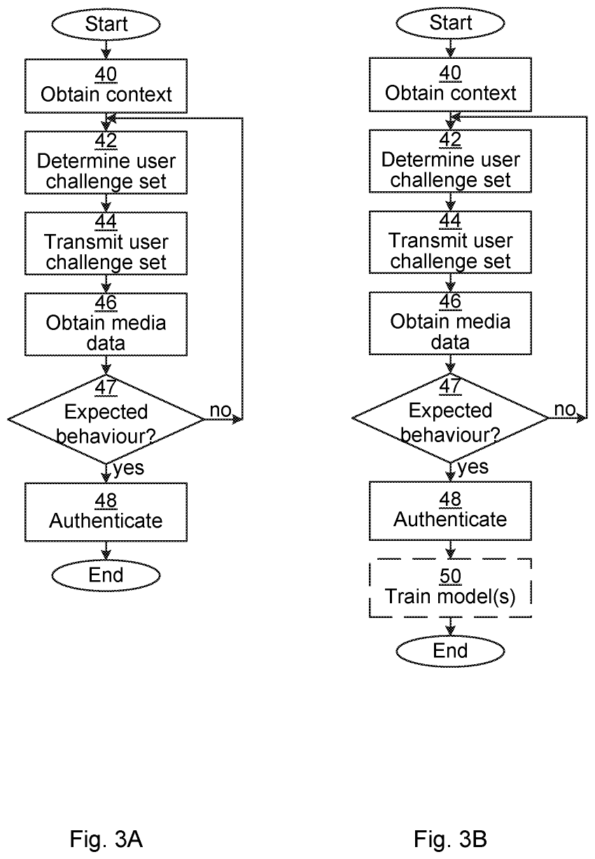

FIGS. 3A-B are flow charts illustrating embodiments of methods for authenticating a user (for a user device), performed in the authenticator 1. The embodiments essentially correspond to the actions of the authenticator 1 of FIG. 2, described above. First, the embodiments illustrated by FIG. 3A will be described. The method starts when the authenticator receives a request to authenticate a particular user 5 from the user device 2. Optionally, prior to the sequence starting, the user has suggested, to the authenticator, objects at the different contexts, e.g. at home (FIG. 1A) and at the office (FIG. 1B) that are objects being suitable for user challenges. It is to be noted that although not specifically mentioned, other contexts than home and the office are equally possible. Suitable actions can also be suggested by the user for the various contexts.

In an obtain context step 40, the authenticator 1 obtains context data reflecting a current context of the user 5. The context data can e.g. comprise an indication of location and/or a timestamp.

The location can e.g. be determined based on location data (such as Wi-Fi access point identifier, cellular access cell identifier, longitude/latitude position, etc.). Alternatively or additionally, the location can be determined based on visual or other data, e.g. room features, unique furniture, room-light characteristics, sound, etc.

The timestamp can also be used as an input to determine location, e.g. using time of day and weekday.

In a determine user challenge set step 42, the authenticator 1 determines a user challenge set for the user 5 to perform based on the context data (and the user identifier). The user challenge set comprises at least one user challenge. Each user challenge indicates an action (touch, move, put, turn, shake, etc.) for the user 5 to perform in relation to at least one object 10a-l. The object and/or action depends on the context and the user identifier, see e.g. the examples of user challenges for home and office above.

At this stage, there is a first opportunity to affect the level of security. For instance, to increase security, further details can be required of the object in one or more user challenges.

At least one object can be a physical object. Alternatively or additionally, at least one object is a virtual object in an extended reality, XR, environment.

The user challenge set can be determined based on a first ML model. The first ML model is thus used to generate one or more challenges that are suited for authenticating the user indicated by the user device.

When there are several user challenges in the user challenge set, the sequence of user challenges can be changed over time to reduce the risk of identical user challenge sets being determined on successive authentications.

The user challenge set can be determined in advance for the user and stored until the request for authentication is received, or the user challenge set can be determined in response to the request for authentication is received.

In a transmit user challenge set step 44, the authenticator transmits the user challenge set to a user device 2, for presenting the user challenge set to the user 5, e.g. as text.

In an obtain media data step 46, the authenticator 1 obtains media data, e.g. video data and optionally audio data from the user device or from another image and sound capturing source in the same location as the user device. Optionally, additional sensor data is obtained in this step, e.g. accelerometer and/or gyroscope data from the user device, etc. The additional sensor data can also include sensor data from external devices. For instance, when the user device is an HMD, accelerometer data of a smartphone can form part of the sensor data. This enables more accurate determinations of user challenges that involve the user handling her smartphone or placing objects in contact with (e.g. on) her smartphone.

In a conditional expected behaviour step 47, the authenticator 1 determines a behaviour of the user 5 captured in the media data, to determine when the media data indicates an expected behaviour of the user 5 in response to the user challenge set. If an expected behaviour is not found, the authentication is considered to fail, and the method returns to the determine user challenge set step 42 for a new user challenge set to be determined. If too many failed attempts occur, the method can end, or proceed with an alternate authentication. If the same user challenge set often fails, succeeded by a successful authentication, this indicates an unsuitable user challenge for the user, and that user challenge set can be avoided or used less frequently in the future for that user. If an expected behaviour is found in the media data, the method proceeds to an authenticate step 48.

The determining whether the media data indicates an expected behaviour of the user 5 can comprise identifying one or more objects in the media data based on a second ML model. The media data, and optionally other sensor data, is detailed enough to detect the behaviour of the user 5 and sufficient detail to distinguish between the object(s), e.g. cup with stripes and a polka-dot cup.

In one embodiment, the determining whether the media data indicates an expected behaviour of the user 5 can comprise determining when the behaviour comprises movement characteristics that are associated with the user 5. Hence, the specific movement pattern of a user can be evaluated, and not only the actions. In other words, in addition to the what (the action(s) and object(s)), the how (indicating a specific movement pattern) is also evaluated, thus providing and extra layer of security.

The expected behaviour can be determined based on a match threshold, i.e. a deviation less than the match threshold is considered to be a match, i.e. that the expected behaviour exists in the media data. The match threshold can also be defined in the reverse, i.e. that an indicator of confidence (in the matching) needs to exceed the match threshold for it to be considered to be a match.

In one example, when the match threshold is strict, the mention of a favourite cup in a user challenge requires the use of the expected cup, but when the match threshold is more lenient, any cup can be sufficient when the user challenge mentions a favourite cup.

In another example, when the match threshold is strict, the mention of a movement of an object from A to B in a user challenge requires that the movement is indeed from A to B, but when the match threshold is more lenient, the reverse movement can be sufficient to consider a match. The same can be applied for order of user challenges in the user challenge set.

The match threshold can depend on security requirements. In other words, where security requirements are high, the match threshold is strict, whereby only a small deviation from expected behaviour is considered to be a match. Alternatively or additionally, the match threshold depends on the context data, e.g. the match threshold is stricter in one location compared to another.

In one embodiment, in addition to media data of video and optionally audio, other sensor data are required to match for a match to be considered, such as accelerometer and/or gyroscope data from the user device, etc.

In one embodiment, the duration of each user challenge, and/or the complete user challenge set is timed, and compared to an expected duration, in which case a match is only considered when the timed duration only deviated from the expected duration less than a timing threshold. The expected duration can depend on the current situation, determined from the context data and/or media data and optionally on user characteristics (e.g. age, fitness level). In one embodiment, the presence or absence of an object at start of user challenge can affect the expected duration differently. In a small studio flat, 30 seconds can be sufficient to fetch something from the kitchen, but this is not sufficient to fetch something in a large mansion from the downstairs kitchen when the user is in an upstairs study. The timing threshold can depend on a desired level of security.

Using the expected duration, some authorisation attacks can be prevented. For instance, as mentioned, 30 seconds is sufficient for the user to fetch something in the kitchen of a small studio flat, but for an attacker being in a flat next door, 30 seconds is not sufficient for the attacker to enter the neighbouring flat and steal the cup.

It is to be noted that the expected behaviour in some cases may be a failure of the user challenge. For instance, if the user challenge is for the user to do a handstand, and the user has never been able to do that, the expected result is that the user does not do a handstand. This type of user challenge can be used to trick an attacker.

In the authenticate step 48, the authenticator considers the user to be authenticated. The successful authentication can then be communicated to the user device 2.

Looking now to FIG. 3B, only new or modified steps compared to those shown in FIG. 3A will be described.

In an optional train model(s) step 50, the authenticator 1 trains the first ML model based on the media data and the context data. Alternatively or additionally, the authenticator 1 trains the second ML model based on the media data and the context data.

Optionally, the training is also based on a result of the authenticating, i.e. if expected behaviour was found or not in the conditional expected behaviour step 47.

Over time, the training identifies objects and/or actions that are used more often, indicating a favourite object or action. Such information is usable for use in user challenges to distinguish the user from an infringer, who does not know what the favourite object and/or action is.

The training is also used to adapt the ML model(s) to movement characteristics that are associated with the user.

The training can occur based on everyday situations in different contexts using input from XR, sensors, smartphone etc. The training can e.g. capture movement patterns, items that are handled, user input on which items that are tagged as favourites, etc.

Using embodiments presented herein, authentication of a user occurs without the need for the user to trust the system owner with any biometric data and without having to remember passwords that are often lengthy and may need regular updates. The user challenge(s) of the authentication is simple for the user to follow by simply following the instructions in the user challenges.

Since no biometric data needs to be stored, and since any given user challenge set may be rather arbitrarily defined by the authenticator (may vary depending on location, task, environment, detected mental status (fear, distress, etc.)), there are many variations of challenges and thus responses. Since the responses can depend on the user, the large number of variations reduce the risk of challenge repeats, whereby a replay attack is less likely.

Moreover, the level of security can be varied by the number of challenges or the tolerances in the matching of expected behaviour.

FIGS. 4A-D are schematic diagrams illustrating embodiments of where the authenticator can be implemented.

In FIG. 4A, the authenticator 1 is shown to be implemented in the user device 2. The user device 2 is thus the host device for the authenticator 1 in this implementation. In this embodiment, the authentication can occur using only internal communication within the user device 2.

In FIG. 4B, the authenticator 1 is shown to be implemented in the server 3. The server 3 is thus the host device for the authenticator 1 in this implementation. The server 3 can have more resources in terms of processing power, communication ability and/or electrical power, than when the authenticator is implemented in the user device 2.

In FIG. 4C, the authenticator 1 is shown to be implemented partly in the user device 2 and partly in the server 3. The user device 2 and the server 3 each serve as host devices for part of the authenticator 1 in this implementation. This is a hybrid solution compared to those of FIG. 4A and FIG. 4B, whereby latency sensitive tasks can be performed in the user device and resource intensive tasks can be performed in the server 3.

In FIG. 4D, the authenticator 1 is shown to be implemented as a stand-alone device. The authenticator 1 thus does not have a host device in this implementation. This provides great flexibility in how the authenticator 1 is implemented.

FIG. 5 is a schematic diagram illustrating components of the authenticator of FIGS. 4A-D according to one embodiment. It is to be noted that when the authentication device 1 is implemented in a host device, one or more of the mentioned components can be shared with the host device. A processor 60 is provided using any combination of one or more of a suitable central processing unit (CPU), graphics processing unit (GPU), multiprocessor, microcontroller, digital signal processor (DSP), etc., capable of executing software instructions 67 stored in a memory 64, which can thus be a computer program product. The processor 60 could alternatively be implemented using an application specific integrated circuit (ASIC), field programmable gate array (FPGA), etc. The processor 60 can be configured to execute the method described with reference to FIGS. 3A-B above.

The memory 64 can be any combination of random-access memory (RAM) and/or read-only memory (ROM). The memory 64 also comprises persistent storage, which, for example, can be any single one or combination of magnetic memory, optical memory, solid-state memory or even remotely mounted memory.

A data memory 66 is also provided for reading and/or storing data during execution of software instructions in the processor 60. The data memory 66 can be any combination of RAM and/or ROM.

The authenticator 1 further comprises an I/O interface 62 for communicating with external and/or internal entities. Optionally, the I/O interface 62 also includes a user interface.

Other components of the authenticator 1 are omitted in order not to obscure the concepts presented herein.

FIG. 6 is a schematic diagram showing functional modules of the authenticator 1 of FIG. 5 according to one embodiment. The modules are implemented using software instructions such as a computer program executing in the authenticator 1. Alternatively or additionally, the modules are implemented using hardware, such as any one or more of an ASIC (Application Specific Integrated Circuit), an FPGA (Field Programmable Gate Array), or discrete logical circuits. The modules correspond to the steps in the methods illustrated in FIGS. 3A-B.

A context obtainer 80 corresponds to step 40. A challenge determiner 82 corresponds to step 42. A challenge transmitter 84 corresponds to step 44. A media data obtainer 86 corresponds to step 46. An expected behaviour determiner 87 corresponds to step 47. An authenticator 88 corresponds to step 48. A trainer 89 corresponds to step 50

FIG. 7 shows one example of a computer program product comprising computer readable means. On this computer readable means, a computer program 91 can be stored, which computer program can cause a processor to execute a method according to embodiments described herein. In this example, the computer program product is in the form of a removable solid-state memory, e.g. a Universal Serial Bus (USB) drive. As explained above, the computer program product could also be embodied in a memory of a device, such as the computer program product 64 of FIG. 6. While the computer program 91 is here schematically shown as a section of the removable solid-state memory, the computer program can be stored in any way which is suitable for the computer program product, such as another type of removable solid-state memory, or an optical disc, such as a CD (compact disc), a DVD (digital versatile disc) or a Blu-Ray disc.

The aspects of the present disclosure have mainly been described above with reference to a few embodiments. However, as is readily appreciated by a person skilled in the art, other embodiments than the ones disclosed above are equally possible within the scope of the invention, as defined by the appended patent claims. Thus, while various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A method for authenticating a user, the method being performed in an authenticator and comprising:
obtaining context data reflecting a current context of the user;
determining a user challenge set for the user to perform based on the context data, the user challenge set comprising at least one user challenge, wherein each user challenge indicates an action for the user to perform in relation to at least one object;
transmitting the user challenge set to a user device, for presenting the user challenge set to the user;
obtaining media data;
determining a behaviour of the user captured in the media data; and
authenticating the user, when the media data indicates an expected behaviour of the user in response to the user challenge set.

2. The method of claim 1, wherein the step of determining a user challenge set is based on a first machine learning (ML) model.

3. The method of claim 2, further comprising the step of:
training the first ML model based on the media data and the context data, wherein
the training is also based on a result of the authenticating.

4. (canceled)

5. The method of claim 2, wherein the step of authenticating comprises identifying one or more objects in the media data based on a second ML model.

6. The method of claim 5, wherein the step of authenticating comprises determining when the behaviour comprises movement characteristics that are associated with the user.

7. The method of claim 1, wherein in the step of authenticating, the expected behaviour is determined based on a match threshold.

8. The method of claim 7, wherein
the match threshold depends on security requirements, and/or
the match threshold depends on the context data.

9. (canceled)

10. The method of claim 1, wherein the steps of determining a user challenge set, transmitting the user challenge set, obtaining media data, and authenticating are repeated when the authentication fails.

11. The method of claim 1, wherein in the step of determining a user challenge set, at least one user challenge omits a detail of the user challenge which is expected to be known by the user, and wherein the step of authenticating comprises verifying presence of the expected detail.

12. The method of claim 1, wherein the context data comprises location data and/or a timestamp.

13. The method of claim 1, wherein at least one object is a physical object.

14. The of claim 1, wherein at least one object is a virtual object in an extended reality environment.

15. An authenticator for authenticating a user, the authenticator comprising:
a processor; and
a memory storing instructions that, when executed by the processor, cause the authenticator to:
obtain context data reflecting a current context of the user;
determine a user challenge set for the user to perform based on the context data, the user challenge set comprising at least one user challenge, wherein each user challenge indicates an action for the user to perform in relation to at least one object;
transmit the user challenge set to a user device, for presenting the user challenge set to the user;
obtain media data;
determine a behaviour of the user captured in the media data; and
authenticating the user, when the media data indicates an expected behaviour of the user in response to the user challenge set.

16. The authenticator of claim 15, wherein the instructions to determine a user challenge set comprise instructions that, when executed by the processor, cause the authenticator to determine the user challenge set is based on a first machine learning (ML) model.

17. The authenticator of claim 16, further comprising instructions that, when executed by the processor, cause the authenticator to:
train the first ML model based on the media data and the context data.

18. The authenticator of claim 17, wherein instructions to train comprise instructions that, when executed by the processor, cause the authenticator to train the first ML model also based on a result of the authenticating.

19. The authenticator of claim 16, wherein the instructions to authenticate comprise instructions that, when executed by the processor, cause the authenticator to identify one or more objects in the media data based on a second ML model.

20. The authenticator of claim 19, wherein the instructions to authenticate comprise instructions that, when executed by the processor, cause the authenticator to determine when the behaviour comprises movement characteristics that are associated with the user.

21. The authenticator of claim 15, wherein the instructions to authenticate comprise instructions that, when executed by the processor, cause the authenticator to, determine the expected behaviour based on a match threshold.

22. The authenticator of claim 21, wherein
the match threshold depends on security requirements, and/or
the match threshold depends on the context data.

23. (canceled)

24. The authenticator of claim 15, further comprising instructions that, when executed by the processor, cause the authenticator to repeat the instructions to determine a user challenge set, transmit the user challenge set, obtain media data, and authenticate when the authentication fails.

25. The authenticator of claim 15, wherein the at least one user challenge omits a detail of the user challenge which is expected to be known by the user, and wherein the instructions to authenticate comprise instructions that, when executed by the processor, cause the authenticator to verify presence of the expected detail.

26. The authenticator of claim 15, wherein the context data comprises location data and/or a timestamp.

27. The authenticator of claim 15, wherein at least one object is a physical object.

28. The authenticator of claim 15, wherein at least one object is a virtual object in an extended reality environment.

29. (canceled)

30. A non-transitory computer readable storage medium storing a computer program for authentication a user, the computer program comprising computer program code which, when executed on an authenticator causes the authenticator to:
obtain context data reflecting a current context of the user;
determine a user challenge set for the user to perform based on the context data, the user challenge set comprising at least one user challenge, wherein each user challenge indicates an action for the user to perform in relation to at least one object;
transmit the user challenge set to a user device, for presenting the user challenge set to the user;
obtain media data;
determine a behaviour of the user captured in the media data; and
authenticating the user, when the media data indicates an expected behaviour of the user in response to the user challenge set.

31. (canceled)
